(19) United States
(12) Patent Application Publication
(10) Pub. No.: US 2026/0229669 A1
(43) Pub. Date: Aug. 6, 2026

(54) BATTERY PACK

(71) Applicant: HONDA MOTOR CO., LTD., Tokyo (JP)

(72) Inventors: Yu IEMURA, Saitama (JP); Shutaro SAO, Saitama (JP); Ken YASUI, Saitama (JP)

(73) Assignee: HONDA MOTOR CO., LTD., Tokyo (JP)

(21) Appl. No.: 19/457,156

(22) Filed: Jan. 23, 2026

(30) Foreign Application Priority Data
Feb. 5, 2025 (JP) 2025-017932

(51) Int. Cl. H01M 50/242; B60L 50/64; H01M 10/613; H01M 10/625; H01M 10/647; H01M 10/6568; H01M 50/209; H01M 50/211; H01M 50/249

(52) U.S. Cl. CPC H01M 50/242; H01M 10/613; H01M 10/625; H01M 10/647; H01M 10/6568; H01M 50/209; H01M 50/211; H01M 50/249; B60L 50/64; H01M 2220/20

(57) ABSTRACT

A battery pack includes: plurality battery cells; a battery case; and a flow path as defined herein, a bottom plate of the battery case includes a first bottom plate and a second bottom plate as defined herein, the flow path is defined between the first bottom plate and the second bottom plate by a recess formed to at least one of the first bottom plate or the second bottom plate, a buckling inhibition portion, which inhibits buckling of the bottom plate when a load is applied to the battery case from outside, is provided inside the flow path, and the buckling inhibition portion includes plural projections as defined herein, and is constituted by disposing the plural projections side by side along an extending direction of the flow path and offsetting the projections adjacent to each other in a width direction of the flow path.

### CROSS-REFERENCE TO RELATED APPLICATION

This application is based on and claims priority under 35 USC 119 from Japanese Patent Application No. 2025-017932 filed on Feb. 5, 2025.

### TECHNICAL FIELD

The present invention relates to a battery pack mounted on a moving object such as a vehicle.

### BACKGROUND ART

In recent years, researches and developments have been conducted on a secondary battery which contributes to improvement in energy efficiency in order to allow more people to have access to affordable, reliable, sustainable and advanced energy.

Patent Literature 1 discloses a battery pack including a cooling mechanism that cools a battery cell by liquid cooling. The cooling mechanism in Patent Literature 1 includes a liquid cooling plate, and the liquid cooling plate is provided with a first recess where a cooling liquid flows and a second recess that is provided at a distance from the first recess and increases rigidity of the liquid cooling plate.

Patent Literature 2 discloses a battery pack including a cooling mechanism that cools a battery cell by liquid cooling. In a partition wall portion between a battery case and a refrigerant flow path, a plurality of projections (pyramids) are disposed in a staggered manner, one of diagonals of the pyramids coincides with a cell lamination direction, and another one of the diagonals of the pyramids coincides with an extending direction of a connecting flow path.

Patent Literature 1: Chinese Utility Model No. 219937177 Specification

Patent Literature 2: Japanese Patent No. 7016844

### SUMMARY OF INVENTION

In a battery pack mounted on a moving object, it is required to improve load bearing performance of a battery case against a load received from the outside. For example, a method of improving the load bearing performance of the battery case by increasing a cross member thickness or increasing the number of reinforcing components is conceivable, but when this method is adopted, there is a problem that a weight of the battery case increases.

The present invention provides a battery pack that can be reduced in weight while improving load bearing performance.

The present invention provides
a battery pack including:
a plurality of battery cells;
a battery case configured to accommodate the battery cells; and
a flow path provided in the battery case and configured to allow a liquid medium for adjusting a temperature of the battery cells to flow therein, in which
a bottom plate of the battery case includes a first bottom plate on an upper surface of which the battery cells are placed, and a second bottom plate overlapping a lower surface of the first bottom plate,
the flow path is partitioned between the first bottom plate and the second bottom plate by a recess formed to at least one of the first bottom plate and the second bottom plate,
a buckling inhibition portion, which inhibits buckling of the bottom plate when a load is input to the battery case from outside, is provided inside the flow path, and
the buckling inhibition portion
   includes a plurality of projections which is formed to at least one of the first bottom plate and the second bottom plate and protrudes toward the other of the first bottom plate and the second bottom plate, and
   is formed by disposing the plurality of projections side by side along an extending direction of the flow path and offsetting the projections adjacent to each other in a width direction of the flow path.

The present invention also provides
a battery pack including:
a plurality of battery cells;
a battery case configured to accommodate the battery cells; and
a flow path provided in the battery case and configured to allow a liquid medium for adjusting a temperature of the battery cells to flow therein, in which
a bottom plate of the battery case includes a first bottom plate on an upper surface of which the battery cells are placed, and a second bottom plate overlapping a lower surface of the first bottom plate,
the flow path is partitioned between the first bottom plate and the second bottom plate by a recess formed to at least one of the first bottom plate and the second bottom plate,
a buckling inhibition portion, which inhibits buckling of the bottom plate when a load is input to the battery case from outside, is provided inside the flow path, and
the buckling inhibition portion
   includes a plurality of projections which is formed to at least one of the first bottom plate and the second bottom plate and protrudes toward the other of the first bottom plate and the second bottom plate, and
   is formed by disposing the plurality of projections side by side along an extending direction of the flow path and disposing a virtual line connecting centerlines of the projections adjacent to each other in a zigzag manner.

According to the present invention, it is possible to achieve weight reduction while improving load bearing performance.

### BRIEF DESCRIPTION OF DRAWINGS

FIG. 1 is a perspective view of a vehicle where a battery pack of an embodiment of the present invention is mounted.

FIG. 2 is a top view of the battery pack in a state in which a cover of a battery case is removed.

FIG. 3 is a bottom view of the battery pack.

FIG. 4 is a cross-sectional view taken along line IV-IV in FIG. 3.

FIG. 5 is an enlarged bottom view of a buckling inhibition portion.

FIG. 6 is an enlarged bottom view of a buckling inhibition portion of a modification.

### DESCRIPTION OF EMBODIMENTS

Hereinafter, an embodiment of a battery pack of the present invention will be described with reference to the accompanying drawings. The battery pack is mounted on a moving object, and in the embodiment, a case where the moving object is a vehicle will be described as an example.

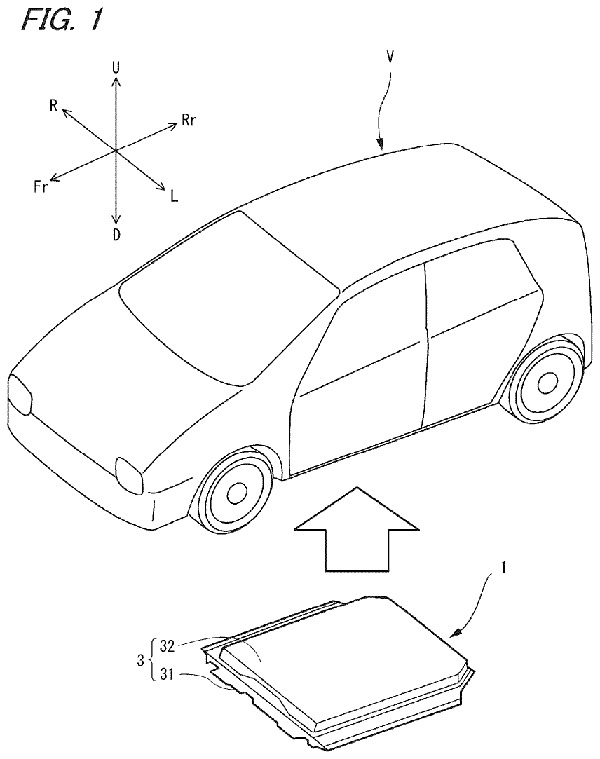

FIG. 1 is a perspective view of a vehicle V where a battery pack 1 of the embodiment of the present invention is mounted. Hereinafter, in order to simplify and clarify the description, in the drawings, a front side of the vehicle V is shown as Fr, a rear side is shown as Rr, a left side is shown as L, a right side is shown as R, an upper side is shown as U, and a lower side is shown as D.

The vehicle V is, for example, an electric vehicle such as an electric automobile, a hybrid vehicle (including a plug-in hybrid vehicle), or a fuel cell vehicle. The battery pack 1 is, for example, attached under a floor of the vehicle V. The battery pack 1 stores and discharges electric power to be supplied to a motor or the like that serves as a drive source for the vehicle V.

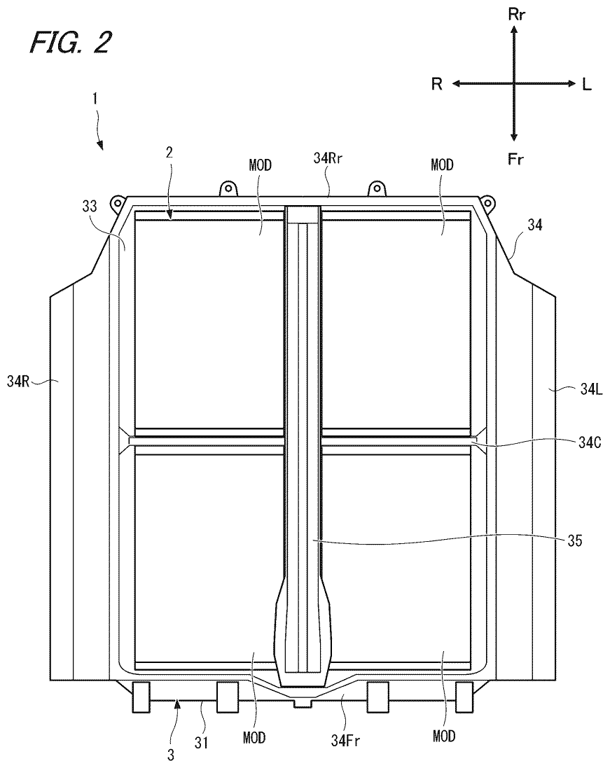

As shown in FIGS. 1 to 3, the battery pack 1 includes a plurality of battery cells 2, a battery case 3 that accommodates the battery cells 2, and a flow path 4 which is provided in the battery case 3 and through which a liquid medium (for example, water) for adjusting a temperature of the battery cells 2 flows.

Each battery cell 2 is, for example, a lithium ion battery or a nickel-metal hydride battery. The battery cell 2 may have a liquid electrolyte or a solid electrolyte (that is, may be a solid-state battery).

The battery cell 2 is, for example, a prismatic or pouch-type battery cell. In the present embodiment, the plurality of battery cells 2 are laminated in a plurality of layers in a left-right direction and modularized in a state of being connected in series and/or in parallel to form a battery module MOD. A total of four battery modules MOD are arranged in two rows in a front-rear direction and in two rows in the left-right direction. The four battery modules MOD are electrically connected to each other via a bus bar (not shown). However, the number of the battery modules MOD is any number, and disposition is also not particularly limited.

The battery cells 2 are not limited to being modularized, and may be accommodated in the battery case 3 in a non-modularized state. The battery cells 2 may be a plurality of cylindrical battery cells accommodated in the battery case 3.

The battery case 3 includes a case body 31 where the battery cells 2 are placed, and a case cover 32 (see FIG. 1) that covers the case body 31 from above.

The case body 31 includes a bottom plate 33 having an upper surface where the battery cells 2 are placed, and a frame member 34 joined to the bottom plate 33 and constituting an outer frame of the case body 31. The case body 31 has a tray shape that can accommodate the battery cells 2.

The frame member 34 is, for example, a cast aluminum member. The frame member 34 is joined to an outer edge of the bottom plate 33 and constitutes front, rear, left, and right side walls of the battery case 3. Specifically, the frame member 34 includes a rear cross member 34Rr extending from a rear edge of the bottom plate 33, a front cross member 34Fr extending from a front edge of the bottom plate 33, and a pair of side frames 34L and 34R extending from left and right edges of the bottom plate 33.

The frame member 34 further includes a central cross member 34C that is provided at a central portion of the bottom plate 33 in the front-rear direction and extends in the left-right direction. The central cross member 34C is disposed between the two battery modules MOD disposed on the front side and the two battery modules MOD disposed on the rear side.

The case body 31 is provided with a bracket 35 provided above the battery cells 2 and extending in the front-rear direction. The bracket 35 is provided at a central portion in the left-right direction and extends from the front cross member 34Fr to the rear cross member 34Rr. For example, an electronic control unit (ECU) and a junction box (which are not shown) are placed at the bracket 35.

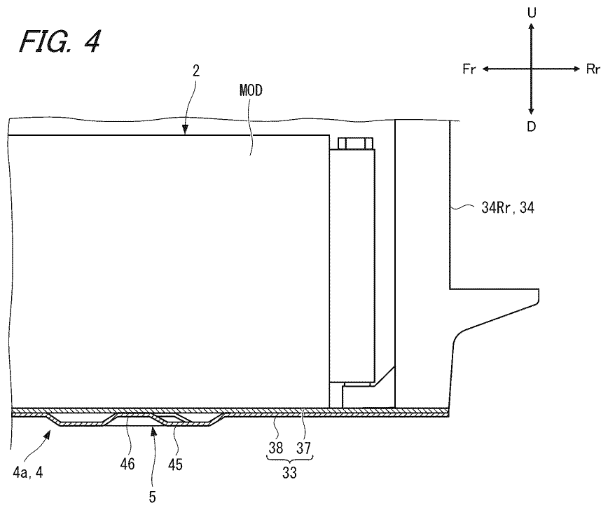

As shown in FIG. 4, the bottom plate 33 includes an upper bottom plate 37 having an upper surface where the battery cells 2 are placed, and a lower bottom plate 38 that overlaps a lower surface of the upper bottom plate 37. The upper bottom plate 37 and the lower bottom plate 38 are joined by, for example, friction stir welding (FSW) or welding.

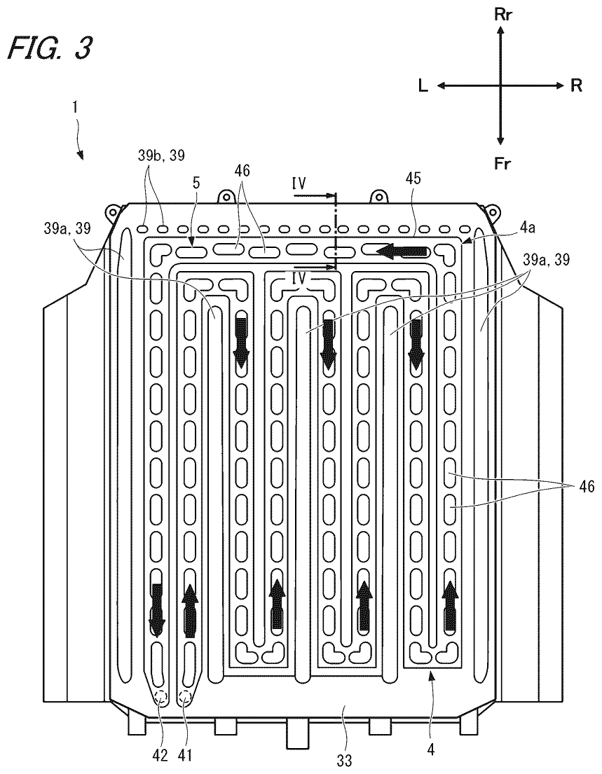

Referring back to FIG. 3, a plurality of protrusions 39 protruding downward are provided integrally (as one component) on the lower bottom plate 38. The protrusions 39 include a plurality of protrusions 39a extending in the front-rear direction and a plurality of protrusions 39b provided along a rear end of the lower bottom plate 38. Since the protrusions 39 receive a load input to the battery pack 1 from the outside, the battery cells 2 and the flow path 4 can be protected.

As shown in FIGS. 3 and 4, the flow path 4 is partitioned between the upper bottom plate 37 and the lower bottom plate 38 by a recess 45 formed to the lower bottom plate 38. The recess 45 is a portion recessed downward in the lower bottom plate 38, and the liquid medium flows through a space partitioned by the recess 45 and the upper bottom plate 37. The flow path 4 functions as a water jacket that adjusts (reduces or increases) the temperature of the battery cells 2 by performing heat exchange between the flowing medium and the battery cells 2.

The recess 45 may be formed to the upper bottom plate 37. In this case, the recess 45 is a portion recessed upward, and the medium flows through a space partitioned by the recess 45 and the lower bottom plate 38. Alternatively, the recess 45 may be formed to both the upper bottom plate 37 and the lower bottom plate 38.

An inlet 41 and an outlet 42 of the flow path 4 are provided at a front end and a left end of the bottom plate 33. As indicated by thick arrows, the medium flows through the flow path 4 from the inlet 41 to the outlet 42. A serpentine flow path is formed in a part of the flow path 4. The serpentine flow path is formed by linear flow paths extending in the front-rear direction, which fold back at a front end side and a rear end side. With the flow path 4 having such a configuration, the temperature of the plurality of battery cells 2 placed on the bottom plate 33 can be adjusted as a whole. The flow path 4 extends in a serpentine manner from the inlet 41 and then extends to the outlet 42 along the outer edge (a rear end and a left end) of the bottom plate 33.

A plurality of projections 46 disposed side by side along a medium flow direction (an extending direction of the flow path 4) are formed inside the flow path 4. Each projection 46 is formed near a center position of the flow path 4 in a width direction (direction orthogonal to the medium flow direction). In the present embodiment, the projection 46 is formed to the lower bottom plate 38 and protrudes upward from the lower bottom plate 38 toward the upper bottom plate 37. When the projection 46 is formed to the upper bottom plate 37, the projection 46 may protrude downward from the upper bottom plate 37.

Each projection 46 has a length along the extending direction of the flow path 4 longer than a length along the width direction of the flow path 4, that is, has an elongated shape along the extending direction of the flow path 4. The projections 46 adjacent to each other along the extending direction of the flow path 4 are spaced apart from each other. In the present embodiment, the projections 46 are formed from the inlet 41 to the outlet 42 along the entire flow path 4.

The projection 46 constitutes at least a part of a joint portion between the upper bottom plate 37 and the lower bottom plate 38. In other words, the upper bottom plate 37 and the lower bottom plate 38 are joined at the projection 46.

Next, load bearing performance of the battery pack 1 will be described with reference to FIGS. 3 to 5. In general, when a large load (for example, a collision load) is input to the battery pack from the outside, in order to reduce deformation of the battery case, a method of improving load bearing performance of a frame member constituting an outer frame of the battery case is conceivable. Specifically, a method of increasing a thickness of the frame member is conceivable, but there is a problem that a weight of the battery pack increases.

The battery pack 1 of the present embodiment has a double structure in which the bottom plate 33 of the battery case 3 includes the upper bottom plate 37 and the lower bottom plate 38, and thus has a structure in which not only the frame member 34 but also the bottom plate 33 can sufficiently receive a load from the outside. The weight can be reduced by preventing an increase in a thickness of the frame member 34 while ensuring load bearing performance of the battery case 3 by the bottom plate 33 having the double structure.

In the structure in which the load bearing performance is ensured using the bottom plate 33 of the battery case 3, it is required to inhibit occurrence of buckling (specifically, out-of-plane buckling) of the bottom plate 33 with respect to a load input from the outside. In particular, occurrence of the buckling of the bottom plate 33 may start from the recess 45 of the bottom plate 33 constituting the flow path 4.

Therefore, in the battery pack 1 of the present embodiment, a buckling inhibition portion 5 that inhibits buckling when a load is input from the outside to the battery case 3 is provided inside the flow path 4. In the present embodiment, the buckling inhibition portion 5 is provided in a rear end side flow path 4a extending in the left-right direction along the rear end of the bottom plate 33 in the flow path 4. However, a position where the buckling inhibition portion 5 is provided is not limited to the rear end side flow path 4a, and the buckling inhibition portion 5 may be provided in the flow path 4 on a right end side and/or a left end side of the bottom plate 33, or may be provided at another position of the flow path 4.

To describe a specific configuration of the buckling inhibition portion 5, the buckling inhibition portion 5 includes the plurality of projections 46 formed in the rear end side flow path 4a and disposed side by side along an extending direction (left-right direction) of the rear end side flow path 4a. Each projection 46 is formed on a bottom surface of the recess 45 of the lower bottom plate 38 and protrudes upward from the bottom surface of the recess 45 toward the upper bottom plate 37.

The buckling inhibition portion 5 is formed by disposing the plurality of projections 46 side by side along the extending direction of the rear end side flow path 4a and offsetting the adjacent projections 46 from each other in a width direction (front-rear direction) of the rear end side flow path 4a.

As an example of a configuration in which the adjacent projections 46 are offset from each other in the width direction, in the present embodiment, the plurality of projections 46 are disposed in a zigzag manner along the extending direction of the rear end side flow path 4a.

According to the buckling inhibition portion 5 having such a configuration, when a large load such as a collision load is received from behind the battery pack 1, occurrence of local stress concentration in the recess 45 can be reduced, and buckling of the bottom plate 33 starting from the recess 45 can be inhibited. In addition, buckling of the bottom plate 33 can be inhibited without providing an additional component.

In this way, when a load is received from the outside, the load can be received by the bottom plate 33 having the load bearing performance, and thus a load burden on the frame member 34 and other reinforcing components (for example, the bracket 35) in the battery case 3 is reduced. As a result, it is possible to reduce a weight of these components and thus reduce a weight of the battery pack 1.

The adjacent projections 46 are offset from each other in the width direction of the rear end side flow path 4a, and partially overlap each other in the width direction. With such a configuration, buckling resistance of the bottom plate 33 can be improved.

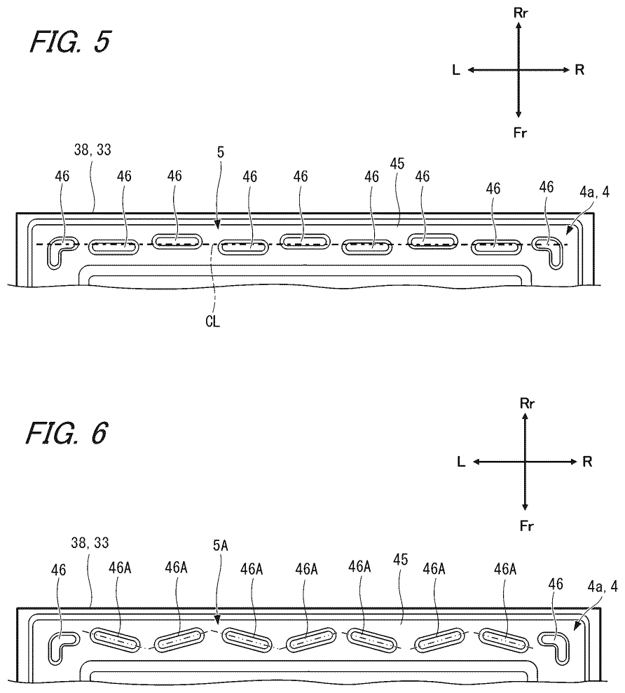

Preferably, each projection 46 overlaps a center position CL (one-dot chain line in FIG. 5) in the width direction of the rear end side flow path 4a. If each projection 46 does not overlap the center position CL, a portion occurs at which a distance between a side surface of the recess 45 and the projection 46 in the width direction of the rear end side flow path 4a is greater than half a width of the rear end side flow path 4a, and buckling is likely to occur. On the other hand, according to this configuration, the distance between the side surface of the recess 45 and the projection 46 can be equal to or less than half the width of the rear end side flow path 4a, and as a result, the buckling resistance of the bottom plate 33 can be improved.

The adjacent projections 46 are spaced apart from each other. Specifically, the adjacent projections 46 do not overlap each other in the extending direction of the rear end side flow path 4a. In this way, since the adjacent projections 46 are not in close contact with each other, the buckling resistance of the bottom plate 33 can be improved.

Each projection 46 has a length along the extending direction of the rear end side flow path 4a longer than a length along the width direction. In addition, each projection 46 is provided such that a longitudinal direction is parallel to the extending direction of the rear end side flow path 4a. The long projection 46 can improve the buckling resistance of the bottom plate 33.

As described above, the upper bottom plate 37 and the lower bottom plate 38 are joined at the projection 46. In other words, in the rear end side flow path 4a, joint portions between the upper bottom plate 37 and the lower bottom plate 38 are disposed in a zigzag manner. In this way, the projection 46, which is the buckling inhibition portion 5, can be used as the joint portion between the upper bottom plate 37 and the lower bottom plate 38. In addition, since the projection 46, which is the buckling inhibition portion 5, is the joint portion between the upper bottom plate 37 and the lower bottom plate 38, the buckling resistance of the bottom plate 33 can be improved.

The buckling inhibition portion 5 of the present embodiment is formed by disposing the plurality of projections 46 in a zigzag manner in the rear end side flow path 4a, and is not provided with a buckling inhibition structure other than the projections 46. Thus, the buckling inhibition portion 5 can reduce a pressure loss between the inlet 41 and the outlet 42 in the flow path 4.

In the flow path 4 including such a buckling inhibition portion 5, a pressure difference of the medium between the inlet 41 and the outlet 42 can be within 40% of a pressure of the medium at the inlet 41. In this way, the buckling inhibition portion 5 can inhibit the buckling of the bottom plate 33 while maintaining cooling efficiency of the battery cells 2.

### Modification

In the above-described embodiment, the buckling inhibition portion 5 includes the plurality of projections 46 disposed side by side along the extending direction of the rear end side flow path 4a and is formed by offsetting the adjacent projections 46 from each other in the width direction of the rear end side flow path 4a, but the configuration is not limited thereto. As shown in FIG. 6, a buckling inhibition portion 5A of a modification is formed by disposing a virtual line (a two-dot chain line in the drawing) connecting centerlines of a plurality of projections 46A in a zigzag manner without offsetting the adjacent projections 46A in the width direction of the rear end side flow path 4a. Such a buckling inhibition portion 5A can also inhibit the buckling of the bottom plate 33 starting from the recess 45.

In the modification, the upper bottom plate 37 and the lower bottom plate 38 are still joined at the projections 46A. Accordingly, the buckling resistance of the bottom plate 33 can be improved.

Although an embodiment and a modification of the present invention have been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, respective constituent elements in the above embodiment may be freely combined without departing from the gist of the invention.

In this specification, at least the following matters are described. In parentheses, corresponding components and the like in the above embodiment are shown as an example, but the present invention is not limited thereto.

(1) A battery pack (battery pack 1) including:
a plurality of battery cells (battery cells 2);
a battery case (battery case 3) configured to accommodate the battery cells; and
a flow path (flow path 4) provided in the battery case and configured to allow a liquid medium for adjusting a temperature of the battery cells to flow therein, in which
a bottom plate (bottom plate 33) of the battery case includes a first bottom plate (upper bottom plate 37) on an upper surface of which the battery cells are placed, and a second bottom plate (lower bottom plate 38) overlapping a lower surface of the first bottom plate,
the flow path is partitioned between the first bottom plate and the second bottom plate by a recess (recess 45) formed to at least one of the first bottom plate and the second bottom plate,
a buckling inhibition portion (buckling inhibition portion 5), which inhibits buckling of the bottom plate when a load is input to the battery case from outside, is provided inside the flow path, and
the buckling inhibition portion
   includes a plurality of projections (projections 46) which is formed to at least one of the first bottom plate and the second bottom plate and protrudes toward the other of the first bottom plate and the second bottom plate, and
   is formed by disposing the plurality of projections side by side along an extending direction of the flow path and offsetting the projections adjacent to each other in a width direction of the flow path.

According to (1), since the battery case has a structure in which a plurality of bottom plates are stacked, an input load from the outside can be received by each bottom plate. In addition, since the buckling inhibition portion formed by offsetting the adjacent projections from each other in the width direction of the flow path is provided inside the flow path, it is possible to improve buckling resistance of the bottom plate without providing an additional component.

In this way, when a load is received from the outside, the load can be received by the bottom plate having load bearing performance, and thus a load burden on a structural member and other reinforcing components in the battery case is reduced. Therefore, it is possible to reduce a weight of the structural member and the reinforcing components, and thus reduce a weight of the battery pack.

(2) The battery pack according to (1), in which
the plurality of projections are disposed in a zigzag manner along the extending direction of the flow path.

According to (2), buckling of the bottom plate can be inhibited by the plurality of projections disposed in a zigzag manner without providing an additional component.

(3) The battery pack according to (1) or (2), in which
the projections adjacent to each other are offset from each other in the width direction of the flow path, and partially overlap each other in the width direction of the flow path.

According to (3), the buckling resistance of the bottom plate can be improved.

(4) The battery pack according to (3), in which
the projections overlap a center position (center position CL) of the flow path in the width direction.

According to (4), a distance between a side surface of the recess and each projection can be equal to or less than half a width of the flow path, and as a result, the buckling resistance of the bottom plate can be improved.

(5) The battery pack according to any one of (1) to (4), in which
the projections adjacent to each other are spaced apart from each other.

According to (5), since the adjacent projections are not in close contact with each other, the buckling resistance of the bottom plate can be improved.

(6) The battery pack according to any one of (1) to (5), in which
a length of each of the projections along the extending direction of the flow path is longer than a length thereof along the width direction of the flow path.

According to (6), the buckling resistance of the bottom plate can be improved by the projections elongated along the extending direction of the flow path.

(7) The battery pack according to any one of (1) to (6), in which
the first bottom plate and the second bottom plate are joined at the projections.

According to (7), each projection protruding to the inner side of the flow path can be used as a joint portion between the first bottom plate and the second bottom plate. In addition, since the projection, which is the buckling inhibition portion, is the joint portion between the first bottom plate and the second bottom plate, the buckling resistance of the bottom plate can be improved.

(8) The battery pack according to any one of (1) to (7), in which
the battery case is provided with an inlet (inlet 41) through which the medium is introduced into the flow path and an outlet (outlet 42) through which the medium is discharged from the flow path, and
a pressure difference of the medium between the inlet and the outlet is within 40% of a pressure of the medium at the inlet.

According to (8), battery cell cooling efficiency can be maintained by reducing a pressure loss in the flow path.

(9) A battery pack including:
a plurality of battery cells;
a battery case configured to accommodate the battery cells; and
a flow path provided in the battery case and configured to allow a liquid medium for adjusting a temperature of the battery cells to flow therein, in which
a bottom plate of the battery case includes a first bottom plate on an upper surface of which the battery cells are placed, and a second bottom plate overlapping a lower surface of the first bottom plate,
the flow path is partitioned between the first bottom plate and the second bottom plate by a recess formed to at least one of the first bottom plate and the second bottom plate,
a buckling inhibition portion (buckling inhibition portion 5A), which inhibits buckling of the bottom plate when a load is input to the battery case from outside, is provided inside the flow path, and
the buckling inhibition portion
   includes a plurality of projections (projections 46A) which is formed to at least one of the first bottom plate and the second bottom plate and protrudes toward the other of the first bottom plate and the second bottom plate, and
   is formed by disposing the plurality of projections side by side along an extending direction of the flow path and disposing a virtual line connecting centerlines of the projections adjacent to each other in a zigzag manner.

According to (9), since the battery case has a structure in which a plurality of bottom plates are stacked, an input load from the outside can be received by each bottom plate. In addition, since the buckling inhibition portion formed by disposing the virtual line connecting the centerlines of the adjacent projections in a zigzag manner is provided inside the flow path, it is possible to improve buckling resistance of the bottom plate without providing an additional component.

### REFERENCE SIGNS LIST

1 battery pack
2 battery cell
3 battery case
33 bottom plate
37 upper bottom plate (first bottom plate)
38 lower bottom plate (second bottom plate)
4 flow path
41 inlet
42 outlet
45 recess
46 projection
46A projection
5 buckling inhibition portion
5A buckling inhibition portion

What is claimed is:

1. A battery pack comprising:
a plurality of battery cells;
a battery case accommodating the battery cells; and
a flow path provided in the battery case and configured to allow a liquid medium for adjusting a temperature of the battery cells to flow in the flow path, wherein
a bottom plate of the battery case includes a first bottom plate on an upper surface of which the battery cells are placed, and a second bottom plate overlapping a lower surface of the first bottom plate,
the flow path is defined between the first bottom plate and the second bottom plate by a recess formed to at least one of the first bottom plate or the second bottom plate,
a buckling inhibition portion, which inhibits buckling of the bottom plate when a load is applied to the battery case from outside, is provided inside the flow path, and
the buckling inhibition portion
includes a plurality of projections which is formed to at least one of the first bottom plate or the second bottom plate and protrudes toward other of the first bottom plate or the second bottom plate, and
is constituted by disposing the plurality of projections side by side along an extending direction of the flow path and offsetting the projections adjacent to each other in a width direction of the flow path.

2. The battery pack according to claim 1, wherein
the plurality of projections are disposed in a zigzag manner along the extending direction of the flow path.

3. The battery pack according to claim 1, wherein
the projections adjacent to each other are offset from each other in the width direction of the flow path, and partially overlap each other in the width direction of the flow path.

4. The battery pack according to claim 2, wherein
the projections adjacent to each other are offset from each other in the width direction of the flow path, and partially overlap each other in the width direction of the flow path.

5. The battery pack according to claim 3, wherein
each of the projections is disposed to overlap a center position of the flow path in the width direction.

6. The battery pack according to claim 4, wherein
each of the projections is disposed to overlap a center position of the flow path in the width direction.

7. The battery pack according to claim 1, wherein
the projections adjacent to each other are spaced apart from each other.

8. The battery pack according to claim 2, wherein
the projections adjacent to each other are spaced apart from each other.

9. The battery pack according to claim 1, wherein
a length of each of the projections along the extending direction of the flow path is longer than a length thereof along the width direction of the flow path.

10. The battery pack according to claim 2, wherein
a length of each of the projections along the extending direction of the flow path is longer than a length thereof along the width direction of the flow path.

11. The battery pack according to claim 1, wherein
the first bottom plate and the second bottom plate are joined at the projections.

12. The battery pack according to claim 2, wherein
the first bottom plate and the second bottom plate are joined at the projections.

13. The battery pack according to claim 1, wherein
the battery case is provided with an inlet through which the medium is introduced into the flow path and an outlet through which the medium is discharged from the flow path, and
a pressure difference of the medium between the inlet and the outlet is within 40% of a pressure of the medium at the inlet.

14. The battery pack according to claim 2, wherein
the battery case is provided with an inlet through which the medium is introduced into the flow path and an outlet through which the medium is discharged from the flow path, and
a pressure difference of the medium between the inlet and the outlet is within 40% of a pressure of the medium at the inlet.

15. A battery pack comprising:
a plurality of battery cells;
a battery case accommodating the battery cells; and
a flow path provided in the battery case and configured to allow a liquid medium for adjusting a temperature of the battery cells to flow in the flow path, wherein
a bottom plate of the battery case includes a first bottom plate on an upper surface of which the battery cells are placed, and a second bottom plate overlapping a lower surface of the first bottom plate,
the flow path is defined between the first bottom plate and the second bottom plate by a recess formed to at least one of the first bottom plate or the second bottom plate,
a buckling inhibition portion, which inhibits buckling of the bottom plate when a load is applied to the battery case from outside, is provided inside the flow path, and
the buckling inhibition portion
includes a plurality of projections which is formed to at least one of the first bottom plate or the second bottom plate and protrudes toward other of the first bottom plate or the second bottom plate, and
is constituted by disposing the plurality of projections side by side along an extending direction of the flow path such that a virtual line connecting centerlines of the projections adjacent to each other extends in a zigzag manner.
